(19) United States
(12) Patent Application Publication
(10) Pub. No.: US 2007/0187442 A1
(43) Pub. Date: Aug. 16, 2007

(54) Doggy camelback

(76) Inventors: Errol Martin, Beaufort, SC (US); Maria Martin, Beaufort, SC (US)

Correspondence Address: JAMES RAY & ASSOCIATES, 2640 PITCAIRN ROAD, MONROEVILLE, PA, 15146, US

(21) Appl. No.: 11/706,095

(22) Filed: Feb. 13, 2007

Related U.S. Application Data
(60) Provisional application No. 60/773,111, filed on Feb. 14, 2006.

(51) Int. Cl. A45F 3/16; A45F 5/00

(52) U.S. Cl. 224/148.2; D30/145

(57) ABSTRACT

An apparatus for use with a pet. The apparatus comprises a backpack having a predetermined size and made of a predetermined material designed to fit on a dog's back. There is a waterproof container member made of a predetermined material and disposed within the backpack for storing water. A first means is disposed on the waterproof container for filling the container and a hose member is connected to the container member for dispensing such one of water and ice water whenever it is needed. A harness means is engageable with the backpack for securing the backpack to a dog's torso.

### CROSS REFERENCE TO RELATED APPLICATIONS

This application is closely related to and claims benefit from U.S. Provisional Application Ser. No. 60/773,111 filed Feb. 14, 2006.

### FIELD OF THE INVENTION

The present invention relates, in general, to a backpack, and, more particularly, the present invention relates to a backpack for a dog to carry in which the backpack contains water for the dog for keeping the dog cool as he goes for a walk with his owner.

### BACKGROUND OF THE INVENTION

Hot temperatures can be dangerous for people, and can even more dangerous for pets. People can cut back on clothing but pets are wearing their “fur coats” even in the hottest weather. Pet owners are constantly seeking convenient ways to keep their much loved pet cool during long walks, particularly in such hot weather. The walks are important for pets to get their exercise and, yet, owners have to be careful not to let the pet(s) go too long without water and not let them get overheated. One problem with this is that while having drinking water available is essential to the pet's health, the transportation of such water is often an inconvenient, unmanageable task.

Thus, it would be advantageous if there were a means available by which such drinking water could be transported so that it would be available as needed and yet not be a burden to either the pet or the owner.

### SUMMARY OF THE INVENTION

In a first aspect the present invention provides an apparatus for use with a pet. The apparatus comprises a backpack having a predetermined size and made of a predetermined material designed to fit on a dog's back. There is a waterproof container member made of a predetermined material and disposed within the backpack for storing water or ice water. A first means is disposed on the waterproof container for filling the container and a hose member is connected to the container member for dispensing such water whenever it is needed. A harness means is engageable with the backpack for securing the backpack to a dog's torso.

### OBJECTS OF THE INVENTION

It is, therefore, one of the primary objects of the present invention is to provide an apparatus that permits the transporting of drinking water without being inconvenient.

Another object of the present invention is to provide a backpack that can be carried on the dog's back for transporting such drinking water.

Still another object of the present invention is to provide a backpack that can be strapped to such dog that is not bothersome to the dog.

Yet another object of the present invention is to provide a backpack for carrying water or ice water that will cool the dog while he is carrying such water on his back.

Another object of the present invention is to provide a backpack that can be carried on the dog's back for transporting such drinking water that is accessible whenever needed while the backpack is still on the pets back.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the backpack for use with a pet according to an embodiment of the invention.

FIG. 2 is a perspective view of the waterproof container that fits into the backpack shown in FIG. 1.

FIG. 3 is a perspective view of a dog having the apparatus shown in FIGS. 1 and 2 mounted on the back of the dog.

FIG. 4 is a perspective view of the dog showing the attachment means across the chest of the dog and also showing the dispensing tube for accessing the water as needed.

FIG. 5 is a perspective view of the dog with the apparatus mounted on the dog's back showing water being dispensed from the tube.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for use with a pet. The apparatus 10 comprises a backpack 2 having a predetermined size and made of a predetermined material designed to fit on a dog's back. There is a waterproof container member 4 made of a predetermined material and disposed within the backpack 2 for storing water or ice water. A first means, generally designated 20, is disposed on the waterproof container 4 for filling the container 4 and a hose member 6 is connected to the container member 4 for dispensing such one of water and ice water whenever it is needed. A harness means, generally designated 30, is engageable with the backpack 2 for securing the backpack 2 to a dog's body.

The harness means 30 includes a first pair of straps 12, a first end of such first pair of straps are attached at a first end thereof to a front end of the backpack 2, such first pair of straps 12 cross over a dog's chest for a secure attachment. The harness means 30 further includes a second pair of straps 14, a first end of such second pair of straps are attached at a first end thereof to a middle portion of the backpack 2, such second pair of straps 14 are designed for encircling such dog's body to further insure a secure attachment.

Another portion or a second end of the first pair of straps 12 are affixed by at least one of a buckle, snaps, and hook and loop material. It is presently preferred that such first pair of straps 12 are affixed by means of hook and loop material 16 (VELCRO). It is further preferred that such hook and loop material is disposed along a portion of a length of the first pair of straps 12 so as to provide a secure fit for such backpack to such dog regardless of the size of such dog. The securing of one strap 12 to the other strap 12 is done along the portion of the straps 12 where the straps 12 cross as seen in FIG. 4 across the chest of the dog.

It is also presently preferred that such second pair of straps 14 are elastic in order to provide for a more secure fit around a waist of such dog and also to not be restrictive to the dog. An opposite end of one of the second pair of straps 14 is secured to an opposite end of another of the second pair of straps 14 by at least one of hook and loop material, snaps or buckles. It is presently preferred that the end of one of the second pair of straps 14 is secured to the end of the other of the second pair of straps 14 by buckles 18. Such buckles can be slid along the second straps 14 so as to fit around the dog securely.

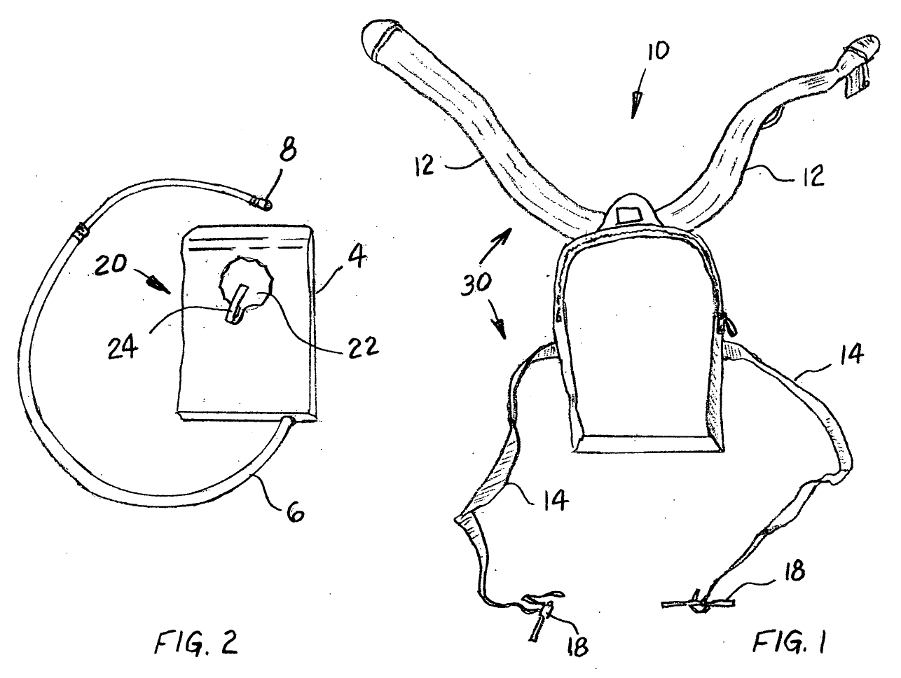

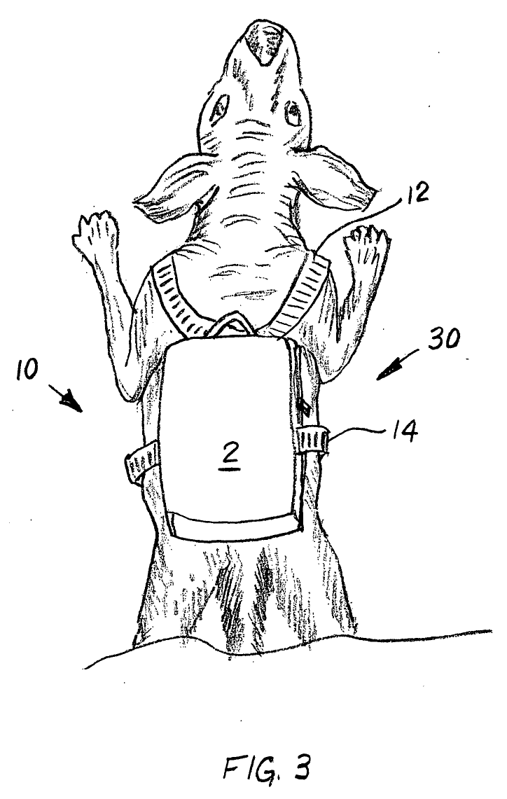

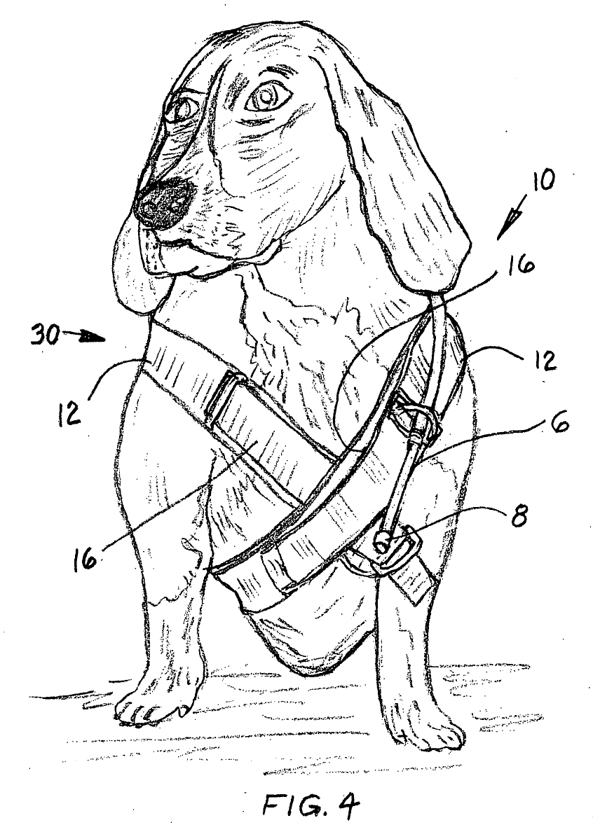

The first means 20 for filling such waterproof container 4 includes an opening in the waterproof container. The opening is closeable by a cap member 22. The cap member 22 is attached to the waterproof container by 4 a flexible strap 24 so that the cap member 24 always remains with the waterproof container 4. This is clearly evident in FIG. 2.

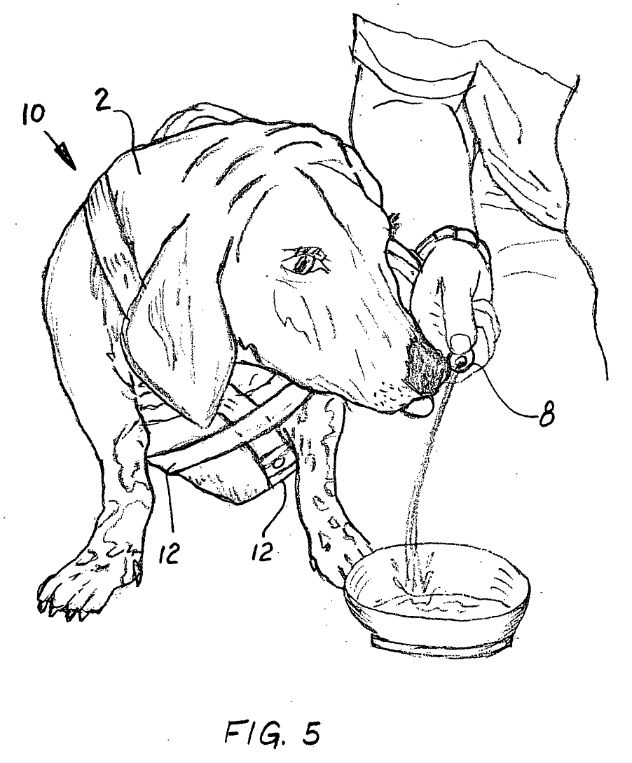

Water or ice water can be dispensed through the hose member 6 at any time such water is desired. The backpack 2 can sill being worn by such dog while the dispensing of water is going on as is seen in FIG. 5.

It is a desirable feature of the invention that water or ice water that is disposed within the waterproof container 4 will help to cool the dog while he is wearing the backpack 2.

The second predetermined material for forming the container member is a plastic material. Such plastic material is flexible so as to fit more comfortably on the dog's back. Such plastic is selected from one of polyethylene, polypropylene and polyvinyl chloride. It is presently preferred that such plastic is polyethylene.

The hose member 6 includes a valve means 8 that is disposed on the end of the hose member 6 for sealing hose 6 in order to keep hose 6 from leaking and for dispensing such water when desired.

Thus, the present invention provides an apparatus which allows pets (dogs) to utilize a backpack that is used to transport water for cooling and drinking purposes. The apparatus is designed to fit a dog like a harness and store water or ice water therein. The apparatus can be affixed to the dog via a buckle, snap, hook and loop material (VELCRO), or any other simple predetermined method. A waterproof plastic container is used to transport the water. The waterproof container fits securely in the backpack. During transport the container with cold or ice water will lay against the material of the backpack keeping it cool, further, transferring the coldness to the back of the dog and thereby cooling the dog.

The container further includes a hose formed as part of the container for dispensing the water whenever desired to allow the dog to drink. The water can be accessed at any time without having to do anything to the container since the end of the hose member is outside of the backpack and thereby is accessible at any time. The back pack is secured by the harness like apparatus which has two separate sets of straps that are used to secure the backpack to the back of the dog.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for use with a pet, said apparatus comprising:
(a) a backpack having a predetermined size and made of a first predetermined material designed to fit on a dog's back;
(b) a waterproof container member made of a second predetermined material and disposed within said backpack for storing water;
(c) a first means disposed on said waterproof container for enabling said container to be filled.
(d) a hose member connected to said container member for dispensing such water when needed; and
(e) a harness means engageable with said backpack for securing said backpack to a dog's body.

2. The apparatus, according to claim 1, wherein said harness means includes a first pair of straps, each one of said first pair of straps attached at a first end thereof to a front end of said backpack, said first pair of straps cross over a dog's chest for a secure attachment.

3. The apparatus, according to claim 2, wherein said harness means further includes a second pair of straps, each one of said second pair of straps attached at a first end thereof to a middle portion of said backpack, said second pair of straps for encircling such dog's body to further insure a secure attachment.

4. The apparatus, according to claim 2, wherein said one of a second end and another portion of each of said first pair of straps is affixed to an opposite one by at least one of a buckle, snaps, and hook and loop material.

5. The apparatus, according to claim 4, wherein said first pair of straps are affixed by means of hook and loop material.

6. The apparatus, according to claim 5, wherein said hook and loop material is disposed along a portion of a length of said each of said first pair of straps so as to provide a secure fit for such backpack to such dog regardless of such size of such dog.

6. The apparatus, according to claim 3, wherein said second pair of straps are elastic so as to provide for a more secure fit around a waist of such dog.

7. The apparatus, according to claim 6, wherein said an opposite end of one of said second pair of straps is secured to an opposite end of another of said second pair of straps by at least one of hook and loop materia, snaps and buckles.

8. The apparatus, according to claim 7, wherein said opposite end of said one of said second pair of straps is secured to said opposite end of said another of said second pair of straps by buckles.

9. The apparatus, according to claim 1, wherein said first means includes an opening in said waterproof container, said opening is closeable by a cap member, said cap member is attached to said waterproof container by a flexible strap so that said cap member always remains with said waterproof container.

10. The apparatus, according to claim 1, wherein such one of water and ice water can be dispensed through said hose member at any time such water is desired with said backpack sill being worn by such dog.

11. The apparatus, according to claim 1, wherein such water disposed within said waterproof container will cool such dog's back while wearing said backpack.

12. The apparatus, according to claim 1, wherein said second predetermined material for forming said container member is plastic.

13. The apparatus, according to claim 12, wherein said plastic is flexible so as to fit more comfortably on such back of such dog.

14. The apparatus, according to claim 1, wherein said plastic is one of polyethylene, polypropylene and polyvinyl chloride.

15. The apparatus, according to claim 14, wherein said plastic is polyethylene.

16. The apparatus, according to claim 1, wherein said hose member includes a valve means on an end of said hose member for sealing said hose in order to keep said hose from leaking and for dispensing such water when desired.
